(19) United States
(12) Patent Application Publication
(10) Pub. No.: US 2010/0090356 A1
(43) Pub. Date: Apr. 15, 2010

(54) LIQUID DESICCANT DEHUMIDIFIER

(75) Inventors: William Tyler Sines, Silver Spring, MD (US); Reinhard Radermacher, Silver Spring, MD (US); Anthony Giampapa, Germantown, MD (US); Kaye L. Brubaker, Washington, DC (US); Matthew William Caplins, Park Hall, MD (US); Amy E. Gardner, Washington, DC (US); John Kucia, College Park, MD (US)

Correspondence Address: PATTON BOGGS LLP, 8484 WESTPARK DRIVE, SUITE 900, MCLEAN, VA, 22102, US

(73) Assignee: LDWorks, LLC, Silver Spring, MD (US)

(21) Appl. No.: 12/576,783

(22) Filed: Oct. 9, 2009

Related U.S. Application Data
(60) Provisional application No. 61/104,553, filed on Oct. 10, 2008.

(51) Int. Cl. B01D 53/18

(52) U.S. Cl. 261/29

(57) ABSTRACT

A dehumidification and regeneration system is described. A liquid desiccant solution may be used to extracts moisture from ambient air in a first location within a dehumidifier with a base. A regenerator in fluid communication with the dehumidifier may extract moisture from the liquid desiccant solution. One or more pumps may circulate the liquid desiccant through the dehumidifier. One or more pumps may circulate the liquid desiccant through the regenerator. The base may expose the liquid desiccant solution at least partially to the ambient air.

### CROSS-REFERENCE TO RELATED APPLICATIONS

This application claims the benefit of U.S. Provisional Patent Application No. 61/104,553, filed Oct. 10, 2008; the content of which is incorporated by reference herein in its entirety.

### FIELD OF THE INVENTION

The present invention relates to the field of dehumidifiers, and, more particularly, to liquid desiccant dehumidifiers.

### BACKGROUND OF INVENTION

Any fountain or waterfall feature that uses water as the working fluid and is open to the indoor atmosphere allows water to evaporate into the air, thereby humidifying the air. The evaporation of water also requires the need to constantly refill the fountain or waterfall to compensate for the evaporated water. In many climates or indoor spaces, additional humidity is undesirable.

Desiccant humidity control is a process that has been around for years and employed at one time or another by every person that has ever bought a brand new pair of shoes. The packet that comes with new shoes is a desiccant material called silica that absorbs moisture from the air in the box to prevent mold from forming. Many current desiccant humidity control systems utilize solid, gel or liquid desiccants.

Current desiccant humidity control systems, however, are not accepted in residential homes and/or for dehumidifying indoor air. Furthermore, existing desiccant humidity control systems do not integrate well with residential buildings.

### SUMMARY OF INVENTION

Embodiments of the present invention may include a dehumidification and regeneration system. A liquid desiccant solution may be used to extract moisture from indoor air in a first location within a dehumidifier with a base. A regenerator in fluid communication with the dehumidifier may extract moisture from the liquid desiccant solution. One or more pumps may circulate the liquid desiccant through the dehumidifier. One or more pumps may also circulate the liquid desiccant through the regenerator. The base may expose the liquid desiccant solution at least partially to the ambient air.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a schematic of a liquid desiccant dehumidifier system according to one embodiment.

FIG. 2 is a schematic of a liquid desiccant dehumidifier system according to one embodiment.

FIG. 3 is an illustration of a liquid desiccant dehumidifier system according to one embodiment.

FIG. 4 is an illustration of a front view of a liquid desiccant dehumidifier according to one embodiment.

FIG. 5 is an illustration of a side view of a liquid desiccant dehumidifier according to one embodiment.

FIG. 6 is an illustration of a side view of a liquid desiccant dehumidifier according to one embodiment.

FIG. 7 is an illustration of a top view of a liquid desiccant dehumidifier according to one embodiment.

### DETAILED DESCRIPTION OF THE EMBODIMENTS

Embodiments of the present invention may include liquid desiccant dehumidifiers and regenerators for the liquid desiccant. In certain embodiments, the dehumidification system may be incorporated into an architectural feature, such as a fountain, “waterfall”, spray chamber or other similar configuration that may enhance contact between ambient air and the liquid desiccant. The contact between the ambient air and the liquid desiccant may remove moisture from the ambient air. Ambient air may be blown across the falling or flowing liquid desiccant solution to further increase dehumidification. Embodiments of the present invention may incorporate dehumidification and latent cooling into an aesthetically pleasing system.

A desiccant is a substance that naturally attracts moisture. By mixing a desiccant solid or liquid with a solvent, such as water, a liquid solution with hygroscopic desiccant properties may be formed. Preferably, a liquid desiccant solution may exhibit viscous properties similar to water, which may allow the liquid desiccant to work well with existing small pumps. Other liquid desiccants with varying properties may be used depending on specific circumstances. Many liquids have desiccant properties, including halide salt solutions, sodium chloride solutions, magnesium chloride solutions, triethylene glycol (TEG) solutions, etc. Solutions of halide salts, such as calcium chloride (CaCl) or lithium chloride (LiCl), may be particularly useful in embodiments of the present invention. In certain embodiments, a liquid form of CaCl may be mixed with water at an approximately 40-60% by weight or approximately 40-60% by volume ratio of desiccant to water.

Liquid desiccants gradually lose effectiveness as they become dilute. Once the liquid desiccant solution has become too diluted, it should be regenerated to continue effectively removing water vapor from indoor air. This process may involve heating the desiccant solution to a temperature such that the water vapor pressure of the desiccant solution exceeds the vapor pressure of the outside air. The heated desiccant may then either be sprayed or dripped over a packed bed to increase the total surface area of the solution while an air stream blows across it. The air stream may remove excess moisture from the heated desiccant and reject the moisture into the outside atmosphere.

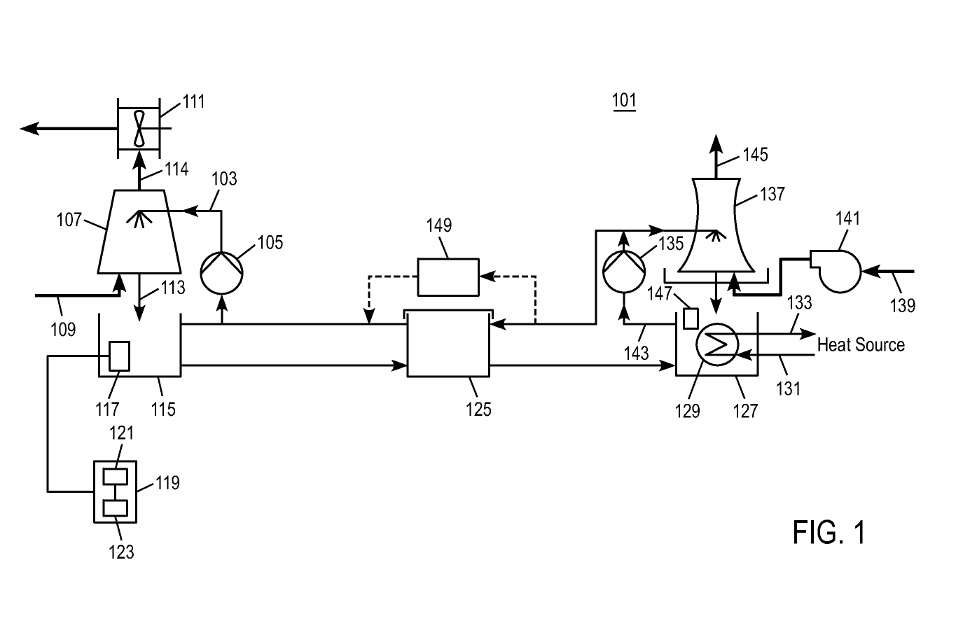

FIG. 1 is a schematic of a liquid desiccant dehumidifier system 101 according to one embodiment. A concentrated liquid desiccant solution 103 may be pumped by a dehumidifier pump 105 through a dehumidifier 107. The dehumidifier 107 may be located in an indoor space of a structure. The dehumidifier 107 may be, for example, but not limited to, a waterfall wall or fountain. The dehumidifier 107 may be housed within a base, where the base at least partially exposes liquid desiccant to ambient air in an architectural liquid feature. The architectural liquid feature may be a waterfall, fountain, spray chamber, or any other similar feature. Preferably, the architectural liquid feature may enhance the aesthetics of an indoor space. The concentrated liquid desiccant solution 103 may preferably be exposed to moist ambient air 109. As the concentrated liquid desiccant solution 103 flows through the dehumidifier 107, the moist ambient air 109 may be circulated across the concentrated liquid desiccant solution 103 by a dehumidifier fan 111. The dehumidifier fan 111 may increase contact between the concentrated liquid desiccant solution 103 and the moist ambient air 109 to create a dilute desiccant solution 113 and dry ambient air 114. In certain embodiments, the concentrated liquid desiccant solution 103 and the moist ambient air 109 may flow in opposite directions. Water vapor may be removed from the indoor air at this interaction due to the difference in vapor pressures between the indoor air and the concentrated liquid desiccant solution 103. The dryer air may then be returned to the space being conditioned reducing the overall relative humidity within the space.

The dilute liquid desiccant solution 113 may be collected in a dehumidifier tank 115. The dilute liquid desiccant solution 113 may be recycled to the dehumidifier 107 by the dehumidifier pump 105 if the dilute liquid desiccant solution 113 is still effective at removing moisture from ambient air. A sensor 117 may determine the specific gravity of the dilute liquid desiccant solution 113. A control unit 119 with a processor 121 and/or a memory 123 may determine whether the dilute liquid desiccant solution 113 is saturated or may be cycled again.

The dilute liquid desiccant solution 113 may be pumped or sent by gravity assist to a storage tank 125. From the storage tank 125, the dilute liquid desiccant solution 113 may be pumped or sent by gravity assist to a regenerator tank 127. A regenerator heat exchanger 129 may input hot fluid 131, such as glycol, and output warm fluid 133 after exchanging heat with the dilute desiccant solution 113. A more concentrated liquid desiccant solution 143 may be pumped by a regenerator pump 135 to a regenerator 137. The regenerator 137 may be located in an outdoor space of a building. Outdoor air 139 may be circulated by a regenerator fan 141 across the more concentrated liquid desiccant solution 143 within the regenerator 137, creating a moisture laden outdoor air stream 145 and concentrating the liquid desiccant solution further. In certain embodiments, the liquid desiccant solution and the dry outdoor air 139 may flow in opposite directions. The liquid desiccant solution is cycled through the regenerator 137 for a set time or until a sensor 147 indicates a suitable saturation level. The concentrated liquid desiccant solution 103 may then be pumped or sent by gravity assist to the storage tank 125 and/or a separate storage tank 149.

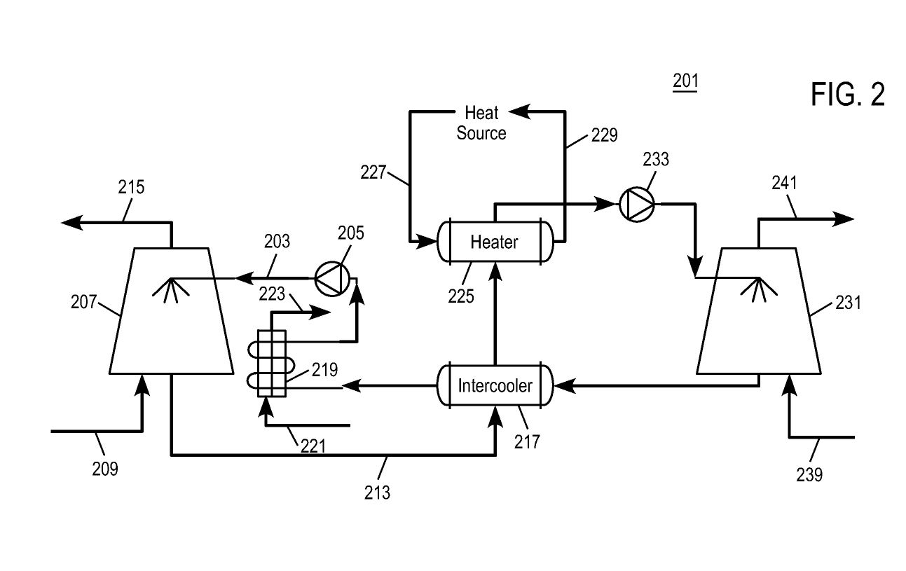

FIG. 2 is a schematic of an alternative liquid desiccant dehumidifier system 201 according to one embodiment. A concentrated liquid desiccant solution 203 may be pumped by a dehumidifier pump 205 through a dehumidifier 207. The dehumidifier 207 may be located in an indoor space of a structure. The dehumidifier 207 may be, for example, but not limited to, a waterfall wall or fountain. The concentrated liquid desiccant solution 203 may preferably be exposed to moist ambient air 209. As the concentrated liquid desiccant solution 203 flows through the dehumidifier 207, the moist ambient air 209 may contact the moist ambient air 209 to create a dilute desiccant solution 213 and dry ambient air 215. In certain embodiments, the concentrated liquid desiccant solution 203 and the moist ambient air 209 may flow in opposite directions. Water vapor may be removed from the indoor air at this interaction due to the difference in vapor pressures between the indoor air and the concentrated liquid desiccant solution 203. The dryer air may then be returned to the space being conditioned reducing the overall relative humidity within the space.

The dilute liquid desiccant solution 213 may be sent to an intercooler 217. The dilute liquid desiccant solution 213 may be recycled to the dehumidifier 207 via a cooler 219 with cool input 221 and warm output 223.

Alternatively, or in addition, the dilute liquid desiccant solution 213 may be sent to a heater 225 with warm inputs 227 and cooler outputs 229. The dilute liquid desiccant solution 213 may pumped with a regenerator pump 233 or sent by gravity assist to a regenerator 231. The regenerator 231 may be located in an outdoor space of a building. Dry outdoor air 239 may contact the dilute liquid desiccant solution 213 creating moist outdoor air 241 and the concentrated liquid desiccant solution 203. In certain embodiments, the dilute liquid desiccant solution 213 and the dry outdoor air 239 may flow in opposite directions. The concentrated liquid desiccant solution 203 may be sent to the cooler 219 through the intercooler 217.

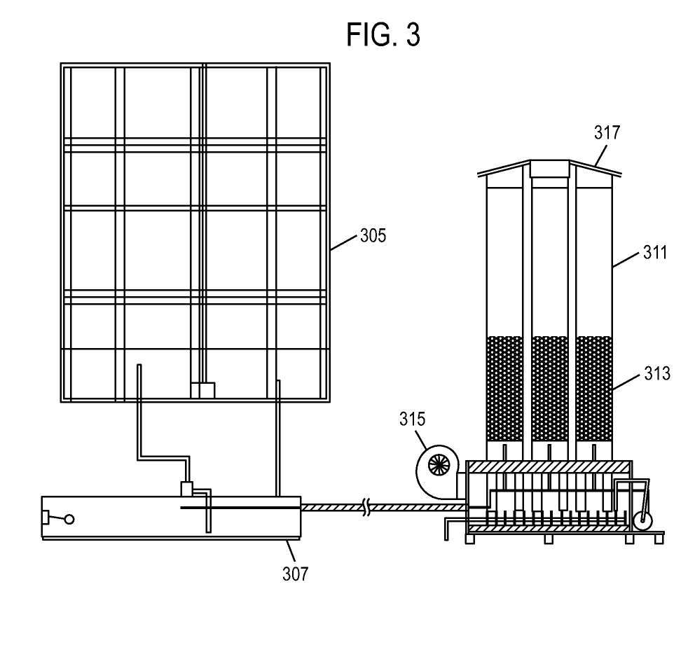

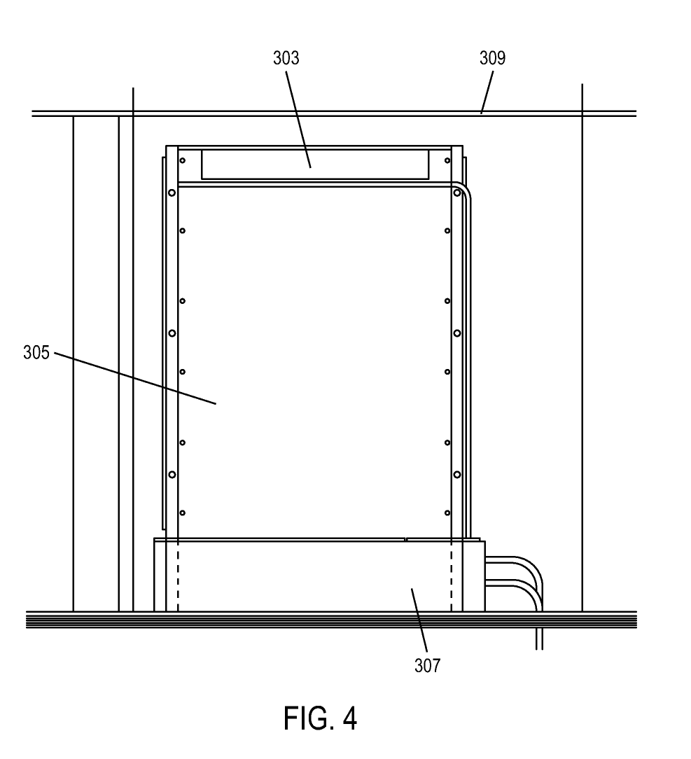

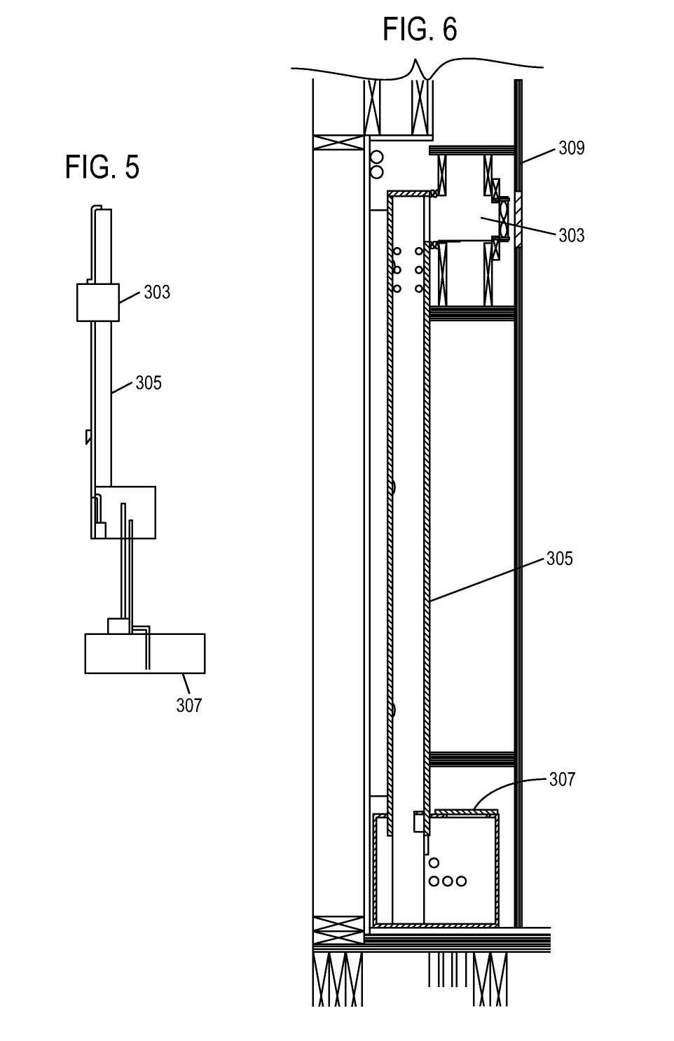

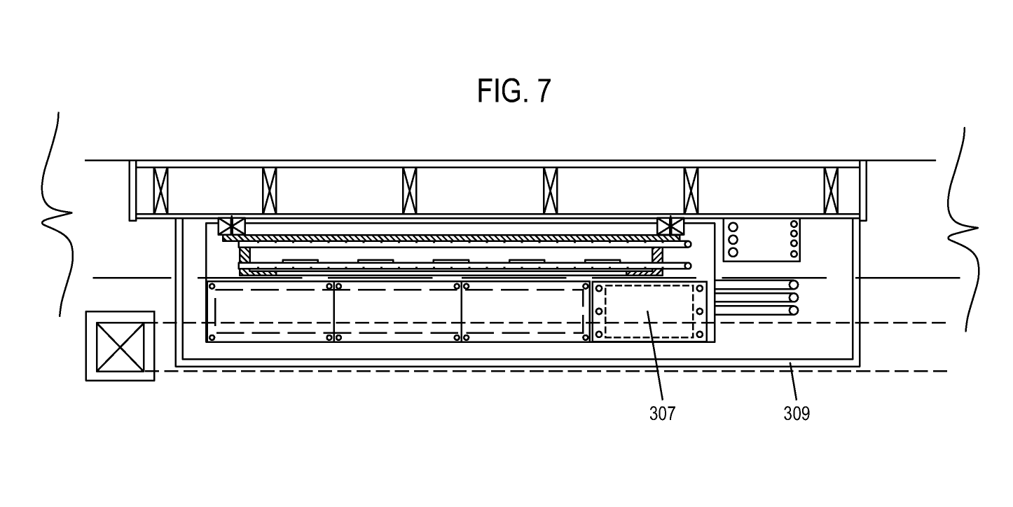

FIGS. 3-7 illustrate various views of an exemplary liquid desiccant dehumidification system.

The specific geometric configuration of the liquid desiccant feature used to circulate the desiccant solution can be a variety of different concepts. The size of the space to be dehumidified should be considered to be proportional to the surface area of desiccant solution interacting with the air. The larger the space, the larger the surface area or effectiveness of bringing air into contact with the desiccant solution (such as packed beds, more turbulent flow etc.) must be. This parameter may affect the flow of the pumps as well; it requires more power to move the appropriate amount of liquid to satisfy the latent load requirements. Another restriction on the design of a water feature may be that all the parts of the feature that come in contact with the solution, including all pumps, must be made of corrosion resistant material such as plastics or titanium. Most liquid desiccants are highly corrosive to all metals, including stainless steels. It is also preferable to have the fans that move the air made entirely of plastic as well. Even though they do not come in direct contact with the liquid solution, some desiccant laden vapor may reach the fans and rust the internal parts.

The present invention may reduce the latent load of the typical vapor compression air conditioning system. The latent load, depending on the climatic region, can account for as much as 60% of the total air conditioning load. This concept is particularly useful in geographic regions where humidity levels are high but no or little sensible cooling is needed, such as the southeastern United States, leading to energy savings and improved comfort. The present invention may also be useful in places where changes in humidity make individuals uncomfortable. If an air conditioner does not have to remove as much moisture from the air, compressor run times can be decreased and energy may be saved. The present invention may also be useful in areas where mold is an issue as drying out the air reduces the chances of the development of mold. The evaporating pressure and temperature of the refrigerant in a conventional air-conditioner can be increased, thus further improving the overall efficiency of the vapor compression air-conditioner.

There may be some energy used to move the liquid and air through the system of the present invention with pumps and fans, respectively. This energy, however, may be minimal in comparison to the energy used to run a compressor to remove the latent load. Energy is required to regenerate the desiccant solution. A preferred method may be to utilize solar heat or waste heat as much as possible. In another implementation, the waste heat rejected from a combined heat and power (CHP) system or the vapor compression cycle may possibly be utilized to regenerate the desiccant solution. A preferred method may be to utilize solar heat or waste heat as much as possible. In another implementation, the waste heat rejected from a combined heat and power (CHP) system or the vapor compression cycle can possibly be utilized to regenerate the desiccant solution.

A desiccant liquid may first be pumped through a chiller to cool it down because a colder desiccant is typically more effective at removing moisture from air. The liquid desiccant may be fed into a basin 303. In certain preferred embodiments, the basin may be elevated. When the basin fills up, the liquid desiccant may overflow on one side creating a waterfall effect, which may occur against a backing 305. Air may be blown in the direction opposite the flow of the liquid desiccant so that interaction between the humid air and the liquid desiccant is maximized. The liquid desiccant then collects in a dehumidifier tank 307 at the bottom of the waterfall to await reuse. The waterfall may be enclosed completely or partially in a housing or base 309.

The concentration of desiccant to water begins to decrease as the water is removed from the air. When the liquid desiccant in the tank reaches a low concentration, it must be regenerated to remove some of the water that has been collected. Regeneration may occur after a set time, continuously, based on measurements of specific gravity of the desiccant, etc. A reservoir tank below the house may hold approximately 50 gallons of desiccant liquid at the proper concentration. A density/buoyancy sensor in the waterfall tank may open a valve and activate a pump to exchange the old desiccant liquid with the reserve liquid. The diluted liquid desiccant may then be regenerated.

To remove water from a chemical mixture it must be evaporated. The liquid desiccant may pass through two heat exchangers before regeneration. The first may be a set of concentric pipes placed within each other extending between the reservoir tank and the regenerator. The smaller may be tubing that may flow liquid from the regenerator to the reservoir tank. The outer pipe may be tubing that may flow water from the reservoir tank to the regenerator. The tanks may be arranged to reduce or minimize the pumping requirements between reservoirs. The inner tube may be connected to a pump that may force high temperature liquid from the regenerator to the reservoir while at the same time exchanging heat with the cooler liquid traveling in the larger pipe coming from the reservoir tank. The next heat exchanger may be a loop off a hot water line to the regenerator tank. This loop may enter and exit the tank near the bottom of the basin. The water traveling through this line may heat the liquid desiccant to an ideal temperature for regeneration.

Once the liquid is heated it may then be pumped from the bottom of the basin to a point midway up one of multiple regenerator towers 311 and sprayed over a material 313. This material may preferably have a large surface area while at the same time allow air and liquid to move freely through the tower. Thus, the liquid may be spread out into a thin film so that evaporation can easily occur. The larger the surface it can spread out on, the thinner the film. At the same time this occurs, air may be blown through the towers by one or more pumps 315, and across the liquid to increase evaporation. The top of the towers may be open to allow air to escape. In certain embodiments, there may be a covering 317 a few inches above the opening to prevent rain or any other material from entering the regenerator. The spray nozzle may be fixed only midway up the tower so that when the air is blown across the liquid, it doesn't spray any droplets out of the tower. The regeneration process may continue until another buoyancy sensor in the reservoir tank reads that the desiccant liquid is at a proper concentration. The system may then shut off and wait to exchange the reservoir liquid with the inside waterfall liquid.

Embodiments of the present invention may include a “waterfall” feature that removes humidity from the air in a quiet, energy efficient and aesthetic manner. With increasing energy prices, the conventional methods of cooling a space may have to change. In a humid climate, removing the latent load (humidity) takes away a large portion of the job from the air conditioner. A conventional air conditioner coupled with a desiccant water fall will run a shorter cycle and can be sized smaller to accommodate for the lighter cooling load. Both of these aspects can save thousands of dollars in energy over time.

### Example

A dehumidifier component was composed of several pieces. The main piece was the dehumidification chamber. This was the main spillway in which the desiccant flowed down and came into contact with inside air. The dehumidification chamber was made of two 6′×6″ sheets of ¾″ cast acrylic screwed into two 6′×4′ sheets of ¾″ cast acrylic sheets to form a rectangular shell with dimensions of 6′×4′×6″ with a thickness of ¾″. Neoprene gaskets were used at each joint to ensure a leak-tight fit. The chamber sat atop of a 4′×18″×12″ holding tank made of ½″ polyethylene, which collected the desiccant as it fell through the chamber. The top of the holding tank that was not covered by the chamber remained open to allow air to enter the tank and pass through the chamber. The holding tank had inlet and outlet connections placed such that the tanks should not be more than half full to ensure that the proper amount of air was able to pass through to the chamber. Two 1057 GPH, 80 watt saltwater aquarium pumps were submerged in the holding tank pump the desiccant to the top of the spillway where they were distributed to the chamber through two acrylic tubes with ⅛″ holes drilled into them at 1¼″ spacing. A galvanized steel duct coated with mastic was attached to the top of the dehumidification chamber that lead to the fan array. The fan array was composed of ten 11-watt CPU fans that pull a maximum total of 700 CFM through the dehumidification chamber.

The regenerator was composed of a holding tank of 20″×36″×20″ dimensions constructed of ½″ high-temperature polyethylene (HTPE). HTPE was used since the holding tank was constructed with a built-in heat exchanger that heated the desiccant solution to at least 80° C. (˜180° F.) for the regeneration process to be effective. The holding tank was insulated using rigid 2″ thick Styrofoam insulation. The tank's built-in heat exchanger was constructed of ½″ diameter titanium tubes connected to each other using polyethylene compression fittings. The heat exchanger also used coiled ¼″ HTPE tubing. Three 8″ diameter holes were cut into the top of the regenerator tank to allow for the regenerator tubes to enter the tank plenum. The regenerator tubes were 8″ diameter acrylic tubes ranging in lengths from 4′ to 6′8. The tubes were capped with vent hoods to prevent rainwater from entering and contaminating the open desiccant system. The desiccant stored in the bottom of the tank was pumped via a 1/10 HP, 1325 GPH pump through ¼″ HTPE tubing run up through the center of each regenerator tube and sprayed down the walls of the tube. A 600 CFM, 50 watt centrifugal fan was connected to the side of the tank to push outside air through the holding tank plenum and up through each regenerator tube where the air came into contact with the hot desiccant and collected the evaporated water. Polyethylene filter material was placed inside each regenerator tube to increase the surface area of the desiccant, maximizing the ability for the collected water to evaporate, as it flowed down the tubes and into the storage tank.

The main storage tank allowed for as much as approximately 90 gallons of desiccant storage. The intercooler was a shell and tube heat exchanger made of concentric HTPE tubes (a ¼″ diameter tube placed inside a 1″ tube) to allow for heat transfer between the solutions entering and leaving the regenerator; in essence the intercooler preheated the entering regenerator fluid. The fluid entering the storage tank from the regenerator was pumped from a branch off of the regenerator pump. Since the main storage tank and the regenerator tank were at equal heights, the desiccant was able to find equilibrium between the two tanks; as fluid was pumped out of the regenerator tank, the decrease in fluid level naturally allowed more desiccant to enter the tank from the main storage tank. The fluid leaving the storage tank to the dehumidifier was pumped, via the dehumidifier pump, through a branch connected to the main storage tank. As the dehumidifier filled up, the desiccant solution overflowed back down to the main storage tank. The main storage tank size was selected such that it can provide ample storage of concentrated desiccant to provide dehumidification ability even when regeneration was not possible.

When the system called for dehumidification (or the user turned the unit on) the dehumidifier pump turned on and pulled concentrated desiccant at approximately 50% from the dehumidifier holding tank and approximately 50% from the main storage tank. The solution from both sources was pumped up to the distribution pipes, which evenly spread the solution along the inside front and rear dehumidification walls. As the desiccant cascaded down the chamber walls, providing the aesthetic appeal of an enclosed waterfall, the desiccant came into contact with the inside air forced through the chamber. The desiccant underwent an enthalpy exchange with the air as it absorbed moisture from the air. The now dilute desiccant solution flowed into the dehumidifier holding tank where it either recirculated through the dehumidification chamber or over flowed back into the main storage tank.

When the system acknowledged regeneration was necessary, as indicated by a control unit with a processor and memory, the regenerator pump turned on and pumped hot, concentrated desiccant from the bottom of the regenerator holding tank to each regenerator tube (approximately 25% of total pump flow goes to each regenerator tube) and to the main holding tank (the remaining 25% of total pump flow returns to the main holding tank). The concentrated desiccant returning to the main holding tank transferred heat with the incoming desiccant through the “tube” of the intercooler before it reached the main holding tank where it finally transferred energy with the bulk desiccant in the holding tank until it reached equilibrium of temperature and concentration. The added volume in the main holding tank forced bulk desiccant through the “shell” of the intercooler where it was preheated until it finally entered the regenerator holding tank where it absorbed heat from the thermal heat source (evacuated tube array) via the heat exchanger built into the regenerator holding tank. The hot desiccant (approximately 80° C.) from the bottom of the regenerator holding tank that was pumped to each of the regenerator tubes was sprayed down the tubes and falls upon the polyethylene filter medium. The filter medium increased the surface area of the desiccant solution, which allowed for higher evaporation rates as the outside air was blown through the tubes. After the excess water was removed from the desiccant, the solution flowed back down to the regenerator holding tank where the process was repeated.

When the system called for dehumidification, the dehumidifier fans turned on. This action pulled air from the conditioned space into the dehumidifier holding tank plenum. The negative pressure in the dehumidification chamber caused the air in the plenum area to be pulled through dehumidification chamber. At this point the inside air came into contact with the desiccant solution and the moisture in the air was condensed into the desiccant solution. This resulted in dehumidified air with a lower enthalpy value to exit the dehumidification chamber and enter the conditioned space, lowering the overall relative humidity within the area.

When the system acknowledged a regeneration opportunity, the regeneration fan turned on forcing outside air into the regenerator holding tank plenum. The positive pressure in the plenum allowed the air to enter the regenerator tubes where the outside air came into contact with the hot desiccant solution. The increase in the desiccant temperature allowed the excess water to evaporate out of the solution and into the outside air stream. The saturated air continued through the regenerator tubes and back into the outside atmosphere.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A dehumidifier apparatus comprising:
a base for providing an architectural liquid feature;
a liquid desiccant solution;
one or more pumps for circulating the liquid desiccant solution through the base;
one or more air circulation devices for circulating air; and
wherein air is blown by the one or more air circulation devices across the liquid desiccant solution when the liquid desiccant solution is exposed to the air by the one or more air circulation devices.

2. The apparatus of claim 1, wherein the liquid desiccant solution is calcium chloride and water.

3. The apparatus of claim 1, further comprising a heater for regenerating the liquid desiccant solution.

4. The apparatus of claim 3, wherein the heater heats the liquid desiccant solution such that the water vapor pressure of the liquid desiccant solution exceeds the vapor pressure of the air.

5. The apparatus of claim 3, wherein the heater is a series of heat exchangers.

6. The apparatus of claim 1, wherein waste heat rejected from a combined heat and power system or a vapor compression cycle is utilized to regenerate the liquid desiccant solution.

7. A method for dehumidifying air, the method comprising:
providing a liquid desiccant solution;
pumping the liquid desiccant solution through a base such that at least a portion of the liquid desiccant solution is exposed to the air, and wherein the base creates an architectural liquid feature; and
blowing the air across the liquid desiccant solution to remove water from the air.

8. The method of claim 7, wherein the liquid desiccant solution is calcium chloride and water.

9. The method of claim 7, further comprising regenerating the liquid desiccant solution.

10. The method of claim 9, wherein the regenerating comprises heating the liquid desiccant solution such that the water vapor pressure of the liquid desiccant solution exceeds the vapor pressure of the air.

11. The method of claim 9, wherein waste heat rejected from a combined heat and power system or a vapor compression cycle is utilized to regenerate the liquid desiccant solution.

12. A dehumidification and regeneration system, the system comprising:
a liquid desiccant solution;
a dehumidifier comprising a base, wherein the dehumidifier extracts moisture from ambient air in a first location via the liquid desiccant solution;
a regenerator in fluid communication with the dehumidifier, wherein the regenerator extracts moisture from the liquid desiccant solution;
one or more pumps for circulating the liquid desiccant through the dehumidifier;
one or more pumps for circulating the liquid desiccant through the regenerator; and
wherein the base exposes the liquid desiccant solution at least partially to the ambient air via an architectural liquid feature.

13. The system of claim 12, further comprising a sensor for determining whether the liquid desiccant is saturated.

14. The system of claim 13, wherein the sensor is a buoyancy sensor.

15. The system of claim 12, wherein waste heat rejected from a combined heat and power system or a vapor compression cycle is utilized to regenerate the liquid desiccant solution.

16. The system of claim 12, wherein the liquid desiccant solution is calcium chloride and water.

17. The system of claim 12, further comprising one or more heat exchangers to modify the temperature of the liquid desiccant solution.

18. The system of claim 12, further comprising one or more fans for circulating air across the liquid desiccant in the dehumidifier.

19. The system of claim 12, further comprising one or more fans for circulating air across the liquid desiccant in the regenerator.

20. The system of claim 12, further comprising one or more pumps for circulating the liquid desiccant between the dehumidifier and the regenerator.
